(19) United States
(12) Patent Application Publication
(10) Pub. No.: US 2026/0266118 A1
(43) Pub. Date: Sep. 10, 2026

(54) OPENER DEVICE FOR A MOTOR VEHICLE DOOR

(71) Applicant: Kiekert Aktiengesellschaft, Heiligenhaus (DE)

(72) Inventors: Marco EGGERT, Düsseldorf (DE); Thorsten BENDEL, Oberhausen (DE); Ömer INAN, Dorsten (DE)

(73) Assignee: Kiekert Aktiengesellschaft, Heiligenhaus (DE)

(21) Appl. No.: 18/993,634

(22) PCT Filed: Jun. 5, 2023
(86) PCT No.: PCT/DE2023/100429

§ 371 Date: Jan. 13, 2025

(30) Foreign Application Priority Data
Jul. 14, 2022 (DE) 10 2022 117 599.5

(51) Int. Cl. E05F 15/611; E05B 85/12

(52) U.S. Cl. CPC E05F 15/611; E05B 85/12; E05Y 2201/422; E05Y 2400/446; E05Y 2900/531

(57) ABSTRACT

The invention relates to an opener device for a motor vehicle door (1), comprising a drive (2; 6, 7) for an opener element (3) and additionally comprising at least one sensor (4) and a holding element (9) which acts on the opener element (3) and/or the motor vehicle door (1). According to the invention, the sensor (4) is designed as a crash sensor (4). The opener element (3) additionally acts on the motor vehicle door (1) on the basis of crash signals of the crash sensor (4), and the holding element (9) secures the motor vehicle door (1) and/or the opener element (3) in the initiated open position.

The invention relates to an opener device for a motor vehicle door, comprising a drive for an opener element and additionally comprising at least one sensor and a holding element acting on the opener element and/or the motor vehicle door.

For aerodynamic reasons, attempts are increasingly being made to design motor vehicles, and in particular their motor vehicle doors, without a door handle for opening from the outside. In order to still be able to open the motor vehicle door, opener devices are provided. By means of the opener device, the motor vehicle door is generally opened after a possible prior question/answer dialog between the operator wishing to enter the vehicle and the motor vehicle in question, and, as applicable, a prior unlocking. This corresponds to a gap between the motor vehicle door and an associated motor vehicle body.

The gap occurs because the drive for the opener element or the door rubber sealing forces usually ensure that the motor vehicle door in question is moved into the slightly open gap position. This usually corresponds to a gap of a few centimeters in relation to the motor vehicle body, which makes it possible to grasp the motor vehicle door with one hand through this gap and swing it open completely. This makes the interior of the motor vehicle accessible.

In an opener device for a motor vehicle door, as described in DE 10 2016 105 760 1, a first sensor is provided which is assigned to a drive element and which can at least distinguish between an automatic opening process and a manual opening process of the motor vehicle door. This is intended to provide a low weight while also providing improved comfort.

In accordance with the further prior art according to DE 10 2018 132 666 A1, a force measuring device with associated sensor is accommodated in an opener device in such a way that a movement of a gear carrier can be detected. The gear carrier represents a component of a gear unit which belongs to an electric motor drive for the opener element and is arranged between the opener element and the electric motor drive.

In the generic prior art according to DE 10 2018 132 665 A1, the motor vehicle door or the associated door element can be held by means of an adjusting means or by means of the opener element. For this purpose, a locking lever is provided, which can be connected in a form-fitting manner to the motor vehicle body. This makes it possible to open the motor vehicle door safely even on sloping roads, because the holding element prevents the motor vehicle door from swinging open in an uncontrolled manner.

In addition, a sensor is realized, with the aid of which a pulling force exerted on the motor vehicle door by an operator can be detected, thereby allowing the locking lever to be unlocked. This frees the motor vehicle door from the body.

The state of the art has proven itself in principle. However, the current approaches reach their limits when, for example, a motor vehicle with handleless motor vehicle doors is involved in an accident. In this case, the electric motor drive for the opener element is usually out of operation, so that additional and separate measures must be taken by arriving safety personnel to open the motor vehicle door. However, when the relevant people arrive at the motor vehicle, they may be confronted with problems such as emergency operating handles not being immediately visible or being damaged themselves. The invention as a whole seeks to remedy this.

The invention is based on the technical problem of further developing such an opener device in such a way that a possible accident or crash can also be brought under control and the door can be simply and quickly opened by arriving safety personnel.

To solve this technical problem, a generic opener device for a motor vehicle door is characterized in the context of the invention in that the sensor is designed as a crash sensor and, on the basis of crash signals, the opener element acts on the motor vehicle door and the holding element secures the motor vehicle door and/or the opener element in the initiated open position.

First of all, it should be noted that the term “motor vehicle door” is to be understood broadly and generally comprehensively within the context of the present teaching of the invention. This includes both motor vehicle side doors and motor vehicle tailgates. Likewise, if applicable, front hoods, motor vehicle sliding doors, loading flaps, etc. This means that, according to the invention, the term motor vehicle door does not only include motor vehicle side doors that allow access to motor vehicle occupants inside the motor vehicle who may be injured. In principle, it is of course also conceivable that, in the event of a crash, an engine hood may have to be opened to extinguish an engine or that a tailgate may need to be opened so that any dangerous load can be removed.

Either way, the crash in question can first be detected with the help of the sensor designed as a crash sensor. This usually corresponds to a deceleration of the motor vehicle in question that exceeds values of several g (where g is the acceleration due to gravity), typically several tens of g. In any case, an accident or crash can be reliably detected using the crash sensor, which is typically connected to a control unit. The control unit then ensures that safety measures are initiated in the motor vehicle, for example a seatbelt tensioner is activated, one or more airbags are triggered, etc.

According to the invention, the crash signal or the multiple crash signals detected by the sensor or crash sensor now result in the motor vehicle door being acted upon by the opener element and being moved into its initiated open position. In principle, the initiated open position can be assumed during the crash, but is generally only implemented after the crash. This means that as soon as the deceleration forces measured by the crash sensor and acting on the motor vehicle have subsided, the relevant crash signal is evaluated by the control unit in such a way that the associated motor vehicle door or several motor vehicle doors are now and subsequently opened (or can be).

The opening of the relevant motor vehicle doors can take place depending on whether the seats are occupied. This means that if, for example, only the driver's seat is occupied, the invention is limited to only opening the driver's door. For safety reasons, the general procedure can be such that all of the motor vehicle's doors are opened to allow the arriving safety personnel full access to the interior of the motor vehicle. For example, it is conceivable that the driver's door is stuck and the injured driver has to be rescued via the passenger door.

The holding element additionally activated in this context ensures that the motor vehicle door is secured in its initiated open position and does not swing open uncontrollably. The same applies alternatively or additionally to the opener element. This is possible, for example, in the event of a rollover or an accident on a slope and must of course be prevented so that any injured persons in the vehicle interior do not tumble out and possibly become injured further.

The overall procedure can be such that the opener element and the holding element are acted on at the same time. It is also conceivable that the opener element first acts on the motor vehicle door and then the holding element secures the motor vehicle door in the initiated open position. In general, and in order to increase functional reliability or avoid any functional problems, the procedure is such that the holding element is first moved to its position securing the motor vehicle door or the opener element and only then does the opener element move the motor vehicle door into the initiated open position.

The usual procedure is to ensure that the gap corresponding to the open position is a few centimeters, for example 10 mm, 20 mm or more, up to generally 50 mm. Since the holding element has usually already assumed its position securing the motor vehicle door when the opener element is acted upon, it is necessary that the holding element can withstand any forces exerted by the opener element on the motor vehicle door and thus also on the holding element. Such forces can be up to about 1 kN. Such opening forces exerted by the opener element on the motor vehicle door are often necessary in order to be able to move a motor vehicle door that may be braced against the motor vehicle body following a crash. In most cases, the corresponding opening forces are between approximately 0.5 kN and 1 kN and can of course be even higher if necessary.

In any case, both the drive for the opener element and the holding element are designed so that they can absorb the aforementioned opening forces. At the same time, this ensures that even following a crash and in the event of a possible distortion of the motor vehicle door to be opened relative to the motor vehicle body, the opening forces are sufficient to provide access to the motor vehicle interior.

In general, the procedure is such that the crash sensor and the drive for the opener element as well as the holding element or preferably a separate and additionally provided drive for the holding element are connected to the previously mentioned common control unit. This allows the control unit to control the drive for the opener element and, as applicable, the additional separate drive for the holding element on the basis of the crash signals emitted by the crash sensor and evaluated by the control unit. As already explained, the typical procedure is that the holding element first assumes its position holding or fixing the motor vehicle door and only then is the opener element then acted on.

In this context, various basic approaches are conceivable. The drive for the opener element can be designed as an electric motor drive. This may serve for normal operation. In addition, an energy storage drive, which is only used in the event of a crash or immediately after the crash, can be provided for the opener element. As an alternative to the energy storage drive, a chemically reactive drive is also conceivable. According to an advantageous embodiment, this can be a pyrotechnic drive, i.e., one in which a chemical reaction is triggered, which generally results in an expansion of a cylinder, which in turn then acts on the opener element to open the motor vehicle door.

In principle, as an alternative or in addition, an electromechanical drive can also be used for the opener element. Such an electromechanical drive usually works without a motor on the opener element, wherein in this context, for example, a shape-memory metal, a piezoelectric drive, etc. is used. The drives already described can be used individually or in any combination. For example, the energy storage drive may be designed as a spring accumulator or may contain one or more such spring accumulators. The energy storage device in question can be equipped with the required energy already at the factory. The energy available in the energy storage device is then used only in the event of a crash to move the opener element into its open position. In this context, the energy storage device can also be used to move vehicle doors that are jammed or blocked in the event of a crash relative to the body into the open position.

Instead of filling the energy storage drive at the factory or realizing an energy storage device or spring accumulator at this point, it is also possible to charge the energy storage device during normal operation via the opener device or the drive for the opener element, either on a regular basis or at certain predetermined intervals. If a spring accumulator is used as the energy storage drive or associated energy storage device, it can be designed in such a way that, when the open position is reached, no force is (any longer) exerted on the holding element already in its holding position or fixing position, so that any damage is thereby avoided. In addition, it is possible to realize the energy storage device or spring accumulator in question by combining two or more springs. Here, it is conceivable that, for example, a strong spring as a component of the energy storage device or spring accumulator acts on the opener element to such an extent that the motor vehicle door is acted on almost to its open position or until shortly before. An additional second, weaker spring can then ensure that the opener element completes the rest of its path to the open position.

In this context, the drive for the opener element can also be equipped with a separate energy source that is independent of a motor vehicle battery. This makes it possible for the drive for the opener element to ensure that the motor vehicle door is opened even if a power supply line to the motor vehicle battery is interrupted in the event of a crash. This separate energy source can be a battery, one or more capacitors, or combinations.

Of course, if an electric motor drive for normal operation on the one hand and an energy storage drive for the event of a crash on the other are realized in parallel, it is also possible to proceed in such a way that both of the aforementioned drives jointly act on the opener element and thus the motor vehicle door. Such a joint action is in principle also possible outside and independently of the crash, for example when a particularly large force has to be overcome on the motor vehicle door in order to be able to open it. This is the case, for example, if the motor vehicle door is frozen. In this case, a force sensor may be realized in addition to the sensor or crash sensor, wherein in this case, depending on signals from the force sensor, the opener element is acted on by means of the electric motor drive for normal operation and, in addition, the energy storage drive.

In principle, the drive in question can also act on a release member for the mechanical energy storage device. This means that in this case the drive itself does not act on the opener element. Rather, the release member is actuated via the drive so that, when the release member is removed or opened, the mechanical energy storage device can release the energy stored in it. In the simplest case, the mechanical energy storage device is the spring accumulator already described in detail above. The release member may be designed as a latch that releases the spring accumulator and is acted on by the drive. In principle, the release member or the latch can be actuated via the drive for the opener element and normal operation, for example in such a way that the drive in question for normal operation is actuated beyond a certain end position, is acted on in the opposite direction, etc. In any case, such a release member generally requires only a small amount of energy from the drive for its actuation, so that in this case the energy source that may be additionally provided for the drive can be designed to be particularly simple, small and lightweight and to have a low capacity, independent of the motor vehicle battery.

In the typical case, the opener element and/or the holding element can be moved into a position that releases the motor vehicle door by means of an actuating means. The actuating means may be a door handle and in particular an interior door handle. Alternatively or additionally, however, an actuating element that is preferably accessible from the outside can also be realized.

In this way, it is possible, for example, for the holding element to be acted on via a door handle or interior door handle. This makes it possible for people inside the motor vehicle who have been involved in an accident to easily open the motor vehicle door, which is secured using the holding element and is in the initiated open position after the crash. Of course, this actuation option also takes into account the possible fact that a child safety lock function is realized on the rear side doors of motor vehicles or that the child safety lock can be engaged. In this case, it has proven to be effective if the actuating means is mechanically coupled to the opener element and/or the holding element via a coupling that can be pushed in and out. In the “child safety lock on” position, the coupling is disengaged so that children in the rear area cannot open the motor vehicle door in question using the door handle or interior door handle, even after an accident. This requires the coupling to be brought into the engaged state so that the relevant rear side door of the motor vehicle can then be opened using the interior door handle as the actuating means.

The actuating element accessible from the outside can be an emergency handle or the like. For this purpose, the actuating means in question may be equipped with a preferably flexible connecting means, for example a Bowden cable, via which the actuating means establishes the required mechanical connection to the holding element and/or the opener element. In this context, it is also conceivable that the actuating element in question, which is accessible from the outside, is marked in the event of a crash, is slightly mechanically exposed or is otherwise identified so that arriving safety personnel can recognize the actuating element in question, which is accessible from the outside, and can immediately open the motor vehicle door. All that is required for this is that the holding element is removed in the typical case from its securing position or from its position holding the motor vehicle door via the actuating element accessible from the outside, so that the motor vehicle door in question can then be easily swung open manually. This is because the motor vehicle door in question is already in its open position following the crash, so that arriving safety personnel can easily grasp a corresponding door leaf through the gap between the door leaf and the motor vehicle body and swing it open.

Lastly, it has proven to be effective if the opener element and/or the holding element engage with a contour of the motor vehicle door. This contour in question is particularly advantageously a lock holder connected to the motor vehicle door. The design is usually such that both the opener element and the holding element engage with the lock holder in question. As a result, any additional measures or additional formations on the motor vehicle door are expressly not necessary because the lock holder functions in the corresponding sense and is used for this purpose.

As a result, an opener device for a motor vehicle door is provided which ensures that the motor vehicle door assumes its open position in the event of a crash. This makes it particularly easy and intuitive for arriving safety personnel to gain access to any persons inside the vehicle who have been involved in an accident. All that is required is to remove the holding element that secures the motor vehicle door in the open position or in the initiated open position. This can either be done quite simply manually through the gap between the motor vehicle door and the motor vehicle body in the initiated open position or open position assumed by the motor vehicle door.

However, it is also possible that, for example, arriving safety personnel act for this purpose on the actuating element accessible from the outside, with the aid of which the holding element is moved from its position securing the motor vehicle door to a position releasing the motor vehicle door. This means that the motor vehicle door is then immediately accessible and can easily be swung open manually.

In this context, it is also advantageous to proceed in such a way that even warped or jammed motor vehicle doors can generally be opened following the crash. For this purpose, the invention generally makes use, additionally and by way of example, of an energy storage drive and/or a chemically reactive drive and/or an electromechanical drive in addition to the electric motor drive for normal operation of the opener element (i.e., outside of the event of a crash). The drives in question provide opening forces that significantly exceed those of the electric motor drive for normal operation. For example, opening forces of up to 1 kN and more can be realized and implemented with such an energy storage drive by using, for example, a spring accumulator.

This greatly increases the overall safety of any vehicle occupants involved in an accident and makes the work of arriving safety personnel significantly easier. In the best case scenario, for example, any tools or crowbars for prying open one or more motor vehicle doors are not required because the opener device according to the invention has already ensured that the motor vehicle door has assumed its open position following the crash. These are the main advantages.

In the following, the invention is explained in more detail with the aid of a drawing showing only one exemplary embodiment; in the figures:

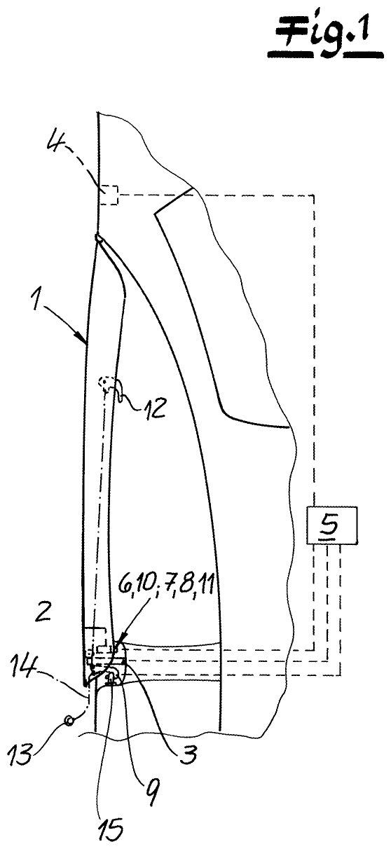

FIG. 1 is a basic overview of the opener device according to the invention,

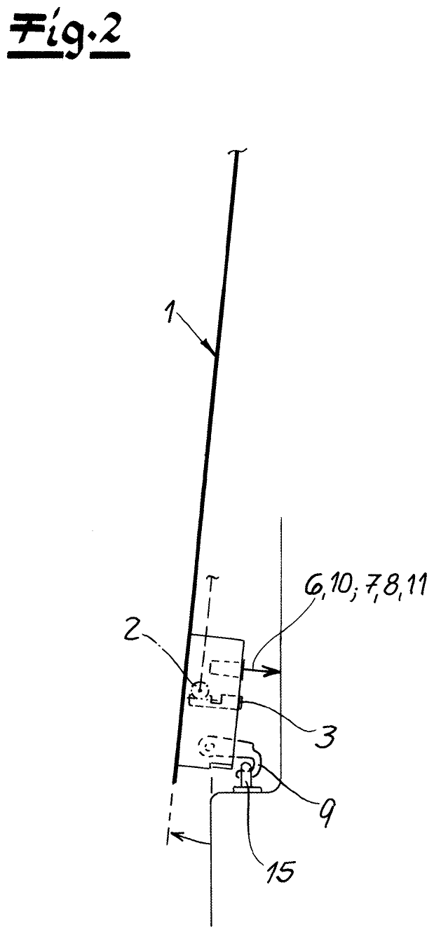

FIG. 2 is a schematic detailed view of the opener device according to FIG. 1.

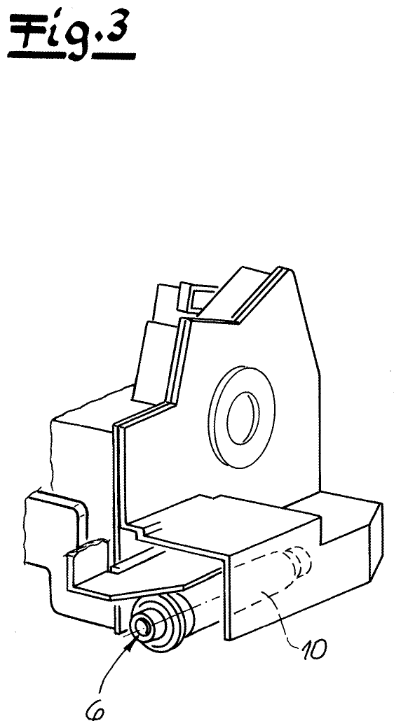

FIG. 3 shows a variant of the invention,

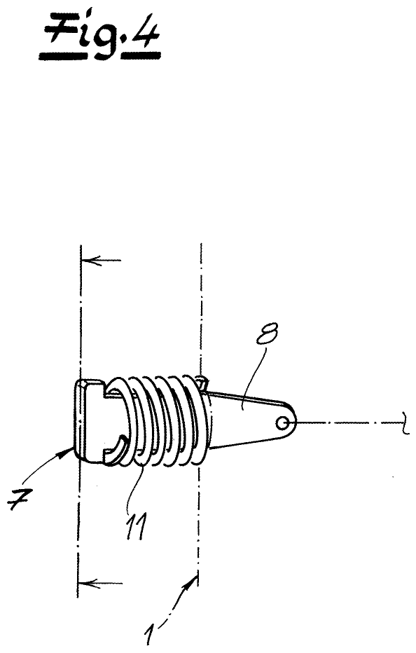

FIG. 4 shows a further variant of the invention, and

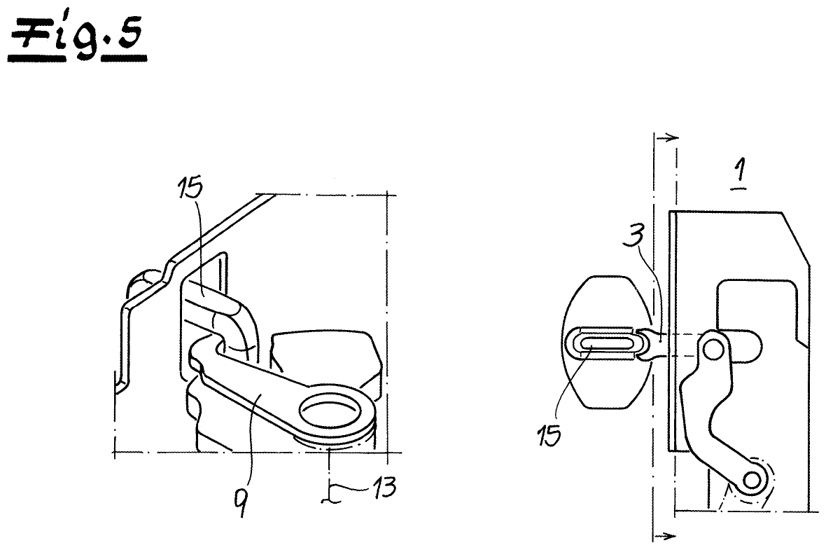

FIG. 5 shows the drive for the opener device of the motor vehicle door in the context of normal operation.

The figures show an opener device for a motor vehicle door 1. In the exemplary embodiment, the motor vehicle door 1 is a front motor vehicle side door 1. In general, however, the motor vehicle door 1 can also be designed as a rear motor vehicle side door, tailgate, etc., as already described in the introduction. For this purpose, the opener device for the motor vehicle door 1 firstly has a drive 2 for an opener element 3. In addition, a sensor 4 indicated in FIG. 1 is realized, which according to the invention is a crash sensor 4. This means that an accident or crash of the associated motor vehicle can be sensed with the help of the sensor or crash sensor 4. This usually corresponds with decelerations that are well above 5 g.

From FIG. 1 it can be seen that, in addition to the drive 2 for the opener element 3, within the scope of the exemplary embodiment and not in a restrictive manner, a further energy storage drive 7 or chemically reactive drive 6 is realized, with the aid of which the opener element 3 can be acted on as an alternative to the drive 2 for normal operation, namely in the event of a crash. In addition, a release member 8 is also realized in this context and will be explained in more detail below.

Of particular importance is a holding element 9 which acts on the motor vehicle door 1. It can be seen that the drive 2 for the opener element 3 in normal operation, the sensor or crash sensor 4 and also the chemically reactive drive 6 or alternatively the energy storage drive 7 as well as the holding element 9 or an associated separate drive for the holding element 9 are connected to a common control unit 5. In this way, the control unit 5 as a whole can be designed and can operate in such a way that, on the basis of crash signals from the crash sensor 4, the opener element 3 or the chemically reactive drive 6 or the energy storage drive 7 act on the opener element 3 and thus the motor vehicle door 1. In addition, the control unit 5 in the exemplary embodiment ensures that the holding element 9 secures the motor vehicle door 1 in the initiated open position.

The drives 2, 6, 7 can be differentiated functionally and conceptually in such a way that the drive 2 for normal operation is hereinafter referred to as the normal operation drive 2, whereas the alternative drives, i.e., the energy storage drive 7 or the chemically reactive drive 6, are hereinafter referred to as crash operation drives 6, 7. Consequently, according to the exemplary embodiment, the crash operation drives 6, 7 are only used when the crash event has been sensed with the aid of the crash sensor 4. In principle, a joint operation of both the normal operation drive 2 and the two crash operation drives 6, 7 is of course also conceivable. However, this is not shown in detail. Also not shown is the further possibility of using an electromechanical drive alternatively or in addition as the crash operation drive 6, 7, as already explained in detail in the description.

The drive 2, 6, 7 can in each case be equipped with a separate energy source 10 that is independent of a motor vehicle battery. In the exemplary embodiment, this separate energy source 10 may be, and is not limited to, an accumulator or a battery, one or more capacitors, etc. In addition, the drive 2; 6, 7 and more specifically the crash operation drive 6, 7 or the energy storage drive 7 can be equipped with a release member 8. In this context, the release member 8 ensures that a mechanical energy storage device 11 releases the energy stored in it. For this purpose, a small amount of electrical energy is sufficient to actuate the release member 8.

Only indicated is an actuating means 12, 13, with the aid of which the opener element 3 and/or the holding element 9 can be acted upon and moved into a position that releases the motor vehicle door 1. According to the exemplary embodiment, the actuating means 12, 13 is a door handle or interior door handle 12. In the example shown, the holding element 9 can be moved from its position securing the motor vehicle door 1 to its position releasing the motor vehicle door 1 via the interior door handle 12. For this purpose, the holding element 9 is simply pivoted out with respect to a lock holder 15, as can be seen from FIG. 5. In fact, the holding element 9, in its position securing the motor vehicle door 1, engages between two brackets of the lock holder 15 in question and ensures that the opened motor vehicle door 1 cannot swing open in an uncontrolled manner.

A similar function is performed by an additionally indicated actuating element 13 which is accessible from the outside. For this purpose, the actuating element 13 may be connected to the holding element 9 by means of a preferably flexible connecting means 14. The flexible connecting means 14 according to the exemplary embodiment is a Bowden cable. Accordingly, the actuating element 13 accessible from the outside being acted on results in the holding element 9 being moved again from its position securing the motor vehicle door 1 to its position releasing the motor vehicle door 1. As a result, the motor vehicle door 1 as a whole can be easily swung open, for example by safety personnel arriving following the described crash grasping the motor vehicle door 1 in the open position through a gap to the motor vehicle body and thereby swinging open the motor vehicle door 1.

Not expressly shown is the further possibility that the actuating means 12, 13 in question and in particular the interior door handle 12 is mechanically coupled to the opener element 3 or the holding element 9 via an engageable and disengageable coupling. This makes it possible, as before and unchanged, to realize and implement a child safety lock function on a rear motor vehicle side door (not shown here). If the associated child safety lock unit is in its “child safety lock on” position, the coupling, which is disengaged in this case, ensures that the holding element 9 cannot be pivoted via the interior door handle 12 and consequently retains its position securing the motor vehicle door 1 in an unchanged manner, even after the crash. This is only released when the holding element 9 is moved, for example from the outside, from its position securing the motor vehicle door 1 to the releasing position or when the previously mentioned coupling is engaged. This is because the interior door handle 12 is then mechanically coupled to the holding element 9, so that an action on the interior door handle 12 ensures that the holding element 9 is moved from its position securing the motor vehicle door 1 to the position releasing the motor vehicle door 1.

The mode of operation is as follows. If the motor vehicle is moved in normal operation, the opener element 3 is acted on by means of the normal operation drive 2 following the question/answer dialog described in the description and the unlocking and, as applicable, electric motor opening of a motor vehicle lock not shown here. For this purpose, the normal operation drive 2 ensures that the motor vehicle door 1 is moved into its open position relative to the motor vehicle body, which is only indicated in FIG. 1. In this open position, the motor vehicle door 1 assumes a gap of a few centimeters in relation to the motor vehicle body, so that an operator wishing to gain access can grasp the motor vehicle door 1 through the gap and swing it open.

If a crash occurs, this is usually associated with the fact that the normal operation drive 2 is electrically disconnected from a motor vehicle battery and therefore generally does not work (or no longer works). In this case, the energy source 10, which is independent of the vehicle battery, ensures that the crash operation drive 6, 7 continues to operate and can move the motor vehicle door 1 into its initiated open position or open position. This happens in the exemplary embodiment and usually after the crash. This means that first the crash sensor 4 registers the crash and reports it to the control unit 5. After the crash or corresponding decelerations have subsided, the control unit 5 evaluates the corresponding crash signals of the crash sensor 4 and ensures that the crash operation drive 6, 7 is activated with the help of the energy source 10, which is independent of the vehicle battery.

The crash operation drive 6, 7 now ensures that, following the crash, the motor vehicle door 1 according to the exemplary embodiment is moved into the open position with the aid of the energy storage drive 7 or by using the chemically reactive drive 6 or both. The crash operation drive 6, 7 can exert a high opening force on the opener element 3 or the motor vehicle door 1, which can be, for example, 1 kN or more. In this way, even a stuck or jammed vehicle door can be opened in the typical case and following a crash.

Previously, the holding element 9 has been moved into its position securing the motor vehicle door 1. As a result, following the crash event, the crash operation drive 6, 7 in the exemplary embodiment ensures that the motor vehicle door 1 is not only moved into its initiated open position with the aid of the opener element 3, but also that the motor vehicle door 1 and, more specifically, the lock holder 15 moves against the holding element 9. In order to keep the forces observed at this point low, according to the individual illustration in FIG. 4 in conjunction with the energy storage drive 7 or the mechanical energy storage device 11 implemented at this point, it is possible to proceed in such a way that the energy storage device 11 acts on the motor vehicle door 1 only until the open position is reached, so that an impact on the holding element 9 is prevented or at least its effect is reduced. For this purpose, it is conceivable, in a variant not shown, to design the mechanical energy storage device in two parts, with a strong and a weak spring.

In this context, the strong spring ensures that the motor vehicle door 1 is opened by acting on the opener element 3 until it almost reaches the open position. The weak spring then ensures that the remaining path to reach the open position is completed and that specifically the lock holder 15 moves against the holding element 9. In any case, the lock holder 15 generally functions as the contour of the motor vehicle door 1, which interacts with the opener element 3 and the holding element 9 according to the exemplary embodiment.

This can be seen best from the individual illustration in FIG. 5. Here it is clear that the opener element 3 as a whole is acted on via a lever drive with the aid of the electric motor drive 2 and moves against the lock holder 15. In the context of the exemplary embodiment, actions of the electric motor drive 2 result in the opener element 3 adjusting the lock holder 15 “to the left”, which corresponds to the motor vehicle door 1 being opened “to the right” relative to the motor vehicle body until the open position is reached.

### LIST OF REFERENCE SIGNS

Motor vehicle door 1
Drive 2
Opener element 3
Crash sensor 4
Control unit 5
Drive 6
Energy storage drive 7
Crash operation drives 6, 7
Release member 8
Holding element 9
Energy source 10
Energy storage device 11
Interior door handle 12
Actuating means 12, 13
Actuating element 13
Connecting means 14
Lock holder 15

1. An opener device for a motor vehicle door, comprising
a drive for an opener element,
at least one sensor, and
a holding element configured to act on the opener element and/or the motor vehicle door,
wherein the sensor is designed as a crash sensor and the opener element acts is configured to act on the motor vehicle door based on crash signals received by the sensor, and
the wherein holding element secures the motor vehicle door and/or the opener element in an initiated open position.

2. The opener device according to claim 1, further comprising a common control unit, wherein the crash sensor and the drive for the opener element are connected to the common control unit.

3. The opener device according to claim 1, wherein the drive for the opener element is designed as an electric motor drive and/or an energy storage drive and/or a chemically reactive drive and/or electromechanical drive.

4. The opener device according to claim 1, further comprising a separate energy source configured to be independent of a motor vehicle battery, wherein the drive is equipped with the separate energy. independent

5. The opener device according to claim 1, further comprising a release member and a mechanical energy storage device, wherein the drive acts on the release member to release the mechanical energy storage device so that the mechanical energy storage device is enabled to release energy.

6. The opener device according to claim 1, further comprising an actuator, wherein the opener element and/or the holding element is moved by the actuator into a position releasing the motor vehicle door.

7. The opener device according to claim 6, wherein the actuator is designed as a door handle and/or an actuating element accessible from an outside of the motor vehicle.

8. The opener device according to claim 7, further comprising a flexible connector, wherein the actuating element is coupled to the holding element and/or the opener element by the flexible connector.

9. The opener device according to claim 6, wherein the actuator is mechanically coupled to the opener element and/or the holding element via an engageable and disengageable coupling.

10. The device according to claim 1, wherein the opener element and/or the holding element engage with a contour of the motor vehicle door.

11. The opener device according to claim 6, wherein the actuator is designed as an interior door handle.

12. The opener device according to claim 10, wherein the opener element and/or the holding element engage with a lock holder connected to the motor vehicle door.

13. The opener device according to claim 2, wherein the control unit is configured to evaluate crash signals emitted by the crash sensor.

14. The opener device according to claim 8, wherein the flexible connector is a Bowden cable.

15. The opener device according to claim 2, wherein the control unit is configured to control the drive for the opener element and the additional separate drive for the holding element based on the crash signals emitted by the crash sensor and evaluated by the control unit.

16. The opener device according to claim 3, wherein the energy storage drive is designed as a spring accumulator.

17. The opener device according to claim 2, further comprising a separate drive for the holding element, wherein the separate drive for the holding element is connected to the common control unit.

18. The opener device according to claim 5, wherein the release member is designed as a latch that releases the mechanical energy storage device.
